(19) United States
(12) Patent Application Publication
(10) Pub. No.: US 2013/0167672 A1
(43) Pub. Date: Jul. 4, 2013

(54) MECHANISM TRANSFORMING ROTATIONAL MOVEMENT TO DIFFERENT MOVEMENT CHARACTERISTICS

(71) Applicant: COSKUNÖZ METAL FORM MAKINA ENDÜSTRI, Bursa (TR)

(72) Inventor: Murat BEYPARS, Bursa (TR)

(73) Assignee: COSKUNÖZ METAL FORM MAKINA ENDÜSTRI VE TIC. A.S., Bursa (TR)

(21) Appl. No.: 13/681,665

(22) Filed: Nov. 20, 2012

Related U.S. Application Data
(63) Continuation of application No. PCT/EP2011/056510, filed on Apr. 25, 2011.

(30) Foreign Application Priority Data
May 20, 2010 (TR) 2010/03996

(51) Int. Cl. F16H 21/22

(52) U.S. Cl. CPC F16H 21/22
USPC 74/42

(57) ABSTRACT

A movement transformation mechanism which is used in presses characterized by comprising an outer crank spindle which is rotated by the first drive source; an outer crank spindle bearing which rotates together with the outer crank spindle and which has an inner crank spindle bearing formed on the lateral surface as eccentric from the center; and an inner crank spindle which is rotated by the second drive source and whereon the connecting rod is hinged, and characterized in that the inner crank spindle is bedded inside said inner crank spindle bearing in a fixed manner.

### CROSS REFERENCE TO RELATED APPLICATIONS

This application is a continuation of International PCT Patent Application No. PCT/EP2011/056510 filed Apr. 25, 2011, which claims the benefit of Turkish Application TR 2010/03996 filed on May 20, 2010, which are incorporated herein by reference in their entireties for all purposes.

### TECHNICAL FIELD

The present invention relates to mechanisms transforming rotational movement to different movement characteristics, it particularly relates to movement transforming mechanisms which is used in presses and where independent power transfer from two separate drive sources to the connecting rod can be realized.

### BACKGROUND

In machines like eccentric press, crank-connection rod mechanisms are used converting rotational movement to linear movement. In more details, such presses operate with the kinetic power of a big circular metal (flywheel) accelerated by an electric motor. Accordingly, the flywheel rotates continuously by means of the rotation movement it takes from the motor, however, the flywheel spindle does not rotate. When it is desired to be pressed on the piece, the flywheel spindle begins rotating by means of a clutch control like pedal. The rotation movement on the flywheel spindle is transferred to the eccentric spindle functioning as a crank by decreasing of the rotation number by means of gears. The function of the eccentric spindle is to transform circular movement to linear movement. Thus, linear movement (it is called press movement distance or stroke in the related technical field) equal to the eccentricity of the crank spindle is realized to the movable ram connected to the rod arm which is connected to the press crank spindle.

This embodiment has some disadvantages. For instance, in general the movement distance (it is called course in the related technical field) in these presses is constant. On the other hand, in press processes, the movement distance of the manufactured piece required with respect to the drawing depth changes. Therefore, in crank-connection rod and link-drive mechanism presses, the press is designed with respect to the maximum movement distance required and it realizes said course in every tour thereof even if most of the time this is not required. This means making the upper mould and the ram body do unnecessary movements and lose energy.

In the presses (course adjusted presses) where the movement distance can be adjusted, this adjustment process is a process which takes a long time and which requires labor. The amount of the eccentricity is determined using a piece called wedge for adjustment whose thickness increases along the length thereof, thus the press movement distance is increased or decreased. For this process, naturally the press should be stopped for a while and thus the production in the line where the press is placed should be stopped for a while. This process which takes a long time to be completed leads to time and production loss in mass production lines. Moreover, in the presses with low tonnage and in C-type presses, automatic course adjustment can be realized.

Moreover, in order to obtain a functional movement characteristic, the displacement distance should be limited in maximum to the radius of the eccentric gear. Thus, for longer distances, eccentric gears with a bigger diameter should be manufactured. This situation limits the movement distance of the press to be produced, with the bench capacity used in thread forming; thus a more advanced technology with bigger gears increases costs.

Another problem is that in these types of presses, particular movement characteristics can not be realized. For instance, in a press application, the press may have to move downwardly with a slow movement, it may have to accelerate after a certain point and it may have to stay for a certain time in press position to the piece. As a result, such a movement characteristics can not be realized by a standard crank-connection rod mechanism. Such an operation can be realized only by expensive systems like servo press in the present art.

As an advantageous and different solution, some press embodiments using a gear box similar to a planet gear system as drive transfer mechanism are disclosed. Planet gear system in general decreases revolution as a gear box, or it can be used for increasing torque or for decreasing torque. Accordingly, the concentricity of the ring gear, the planet carrier and the sun gear provides an important advantage in the fields requiring concentric power transfer. The planet gear systems which are the subject of these patents realize the transformation of rotational movement to linear movement; therefore they are used for a different purpose.

As a result, because of the abovementioned disadvantages, a novelty is required in the related technical field.

### SUMMARY

The present invention is a novel movement transformation mechanism used in presses, in order to eliminate above mentioned disadvantages and to bring new advantages to the relevant technical field.

An object of the subject matter invention is to provide a movement transformation mechanism which can transform rotational movement to different movement characteristics.

Another object of the subject matter invention is provide a movement transformation mechanism which provides the realization of the adjustments of course, tuning or stroke characteristics of the press without the need for a structural change and which provides the realization of the abovementioned processes with respect to the piece to be shaped.

Another object of the subject matter invention is to provide movement transformation mechanisms with gear boxes similar to planet gear group to become more resistant to high level of forces.

In order to provide this, the subject matter movement transformation mechanism is driven simultaneously by two different drive sources and it transfers this drive to the connecting rod. Accordingly, thanks to the suitable electronic control of said drive sources and thanks to the specific construction of the movement transformation mechanism arranging the dependent movement of the two independent drives taken, an infinite number of different movement characteristics can be obtained at the output.

In order to realize all of the objects obtained from the above explanation and the below mentioned detailed explanation, the subject matter invention relates to a movement transformation mechanism which is used in presses and where independent power transfer can be realized to the connecting rod from two separate drive sources. Said mechanism comprises an outer crank spindle with circular gear form which is rotated by the first drive source; an outer crank spindle bearing which is connected to said outer crank spindle in a fixed manner and thereby which rotates together with the crank spindle and which has an inner crank spindle bearing formed on the lateral surface as eccentric from the center; and an inner crank spindle which is rotated by the second drive source and which has an eccentric part whereon the connecting rod is hinged. Depending on this, moreover, in said mechanism, the inner crank spindle is rotatably bedded inside said inner crank spindle bearing, in order for the inner crank spindle to rotate around itself and at the same time, in order to provide the inner crank spindle to make orbital movement together with the outer crank spindle bearing.

In a preferred embodiment of the present invention, in order to transfer the movement of said first drive source to the outer crank spindle, there is an outer crank spindle drive gear in connection with the first drive source, and there is a geared surface which is in connection with said outer crank spindle drive gear and which is formed at the outer circumference of the outer crank spindle.

In another preferred embodiment of the present invention, in order to transfer the movement of said second drive source to the inner crank spindle, there is an inner crank spindle drive gear connected to the second drive source and there is an inner crank spindle gear which is connected to said inner crank spindle drive gear and which is connected to the inner crank spindle in a fixed manner.

In another preferred embodiment of the present invention, there is an inner crank spindle bushing, in order to provide the bearing of the inner crank spindle firmly inside said inner crank spindle bearing.

In another preferred embodiment of the present invention, there is an outer crank spindle bushing which is placed onto the seating surface forming the outer circumference of the outer crank spindle bearing.

In another preferred embodiment of the present invention, the outer crank spindle bearing is placed into the bearing slot in a rotatable manner which exists on the upper bridge of a press.

In another preferred embodiment of the present invention, said outer crank spindle bearing has a cylindrical form extending orthogonally during operation and accordingly, it is formed eccentrically from the center on the lateral surface of the inner crank spindle bearing.

In another preferred embodiment of the present invention, there is an inner crank spindle pivot which is placed to the inner crank spindle bearing of the inner crank spindle; said eccentric part extending at the continuation of said inner crank spindle pivot; and an arm connection pivot which extends at the continuation of said eccentric part and whereon the connecting rod is connected.

In another preferred embodiment of the present invention, said first and second drive sources are one each servo motor.

The structural and the characteristic features and all the advantages of the subject matter invention can be understood more precisely by means of the detailed explanation which is written with references to these figures and therefore, it had to be evaluated with the detailed explanation and figures that are explained below.

### BRIEF DESCRIPTION OF THE DRAWINGS

FIG. 1 is a perspective view of the subject matter mechanism.

FIG. 2 is an exploded view of the subject matter mechanism of FIG. 1.

FIG. 3 is a cross sectional view of the subject matter mechanism of FIG. 1.

FIG. 4a is a representative figure of a first example operation position adjustment of the subject matter mechanism of FIG. 1.

FIG. 4b is a representative figure of a second example operation position adjustment of the subject matter mechanism of FIG. 1.

FIG. 4c is a representative figure of a third example operation position adjustment of the subject matter mechanism of FIG. 1.

FIG. 4d is a representative figure of a fourth example operation position adjustment of the subject matter mechanism of FIG. 1.

FIG. 5 is an illustration of the course adjustment of the subject matter mechanism of FIG. 1.

FIG. 6a is a representative figure of the FIG. 1 subject matter mechanism's orbits.

FIG. 6b is a representative figure of the subject matter mechanism of FIG. 1, where the orbits are illustrated to have a second example function.

FIG. 6c is a route-time graphic of the orbit in FIG. 6a.

FIG. 7a is a representative figure of the subject matter mechanism of FIG. 1, where the orbits are illustrated to have a third example function.

FIG. 7b is a route-time graphic of the orbit in FIG. 7a.

FIG. 8a is a representative figure of the subject matter mechanism of FIG. 1, where the orbits are illustrated to have a fourth example function.

FIG. 8b is a route-time graphic of the orbit in FIG. 8a.

FIG. 8c is a representative figure of the subject matter mechanism of FIG. 1, where the orbits are illustrated to have a fifth example function.

FIG. 8d is a route-time graphic of the orbit in FIG. 8c.

FIG. 8e is a representative figure of the subject matter mechanism of FIG. 1, where the orbits are illustrated to have a sixth example function.

FIG. 8f is a route-time graphic of the orbit in FIG. 8e.

FIG. 9 is a representative figure illustrating the dimensional comparison of the subject matter mechanism of FIG. 1 with a known eccentric press mechanism.

### DETAILED DESCRIPTION

In this detailed explanation, the subject matter mechanism is explained with examples in order to make the subject matter more understandable without forming any restrictive effect. Accordingly, in the explanation below and in the subject matter figures, the subject matter invention is assumed to be applied in providing movement of the ram of a press. However, in alternative embodiments, the subject matter invention can also be used in any field where rotational movement is required to be transformed into different movements.

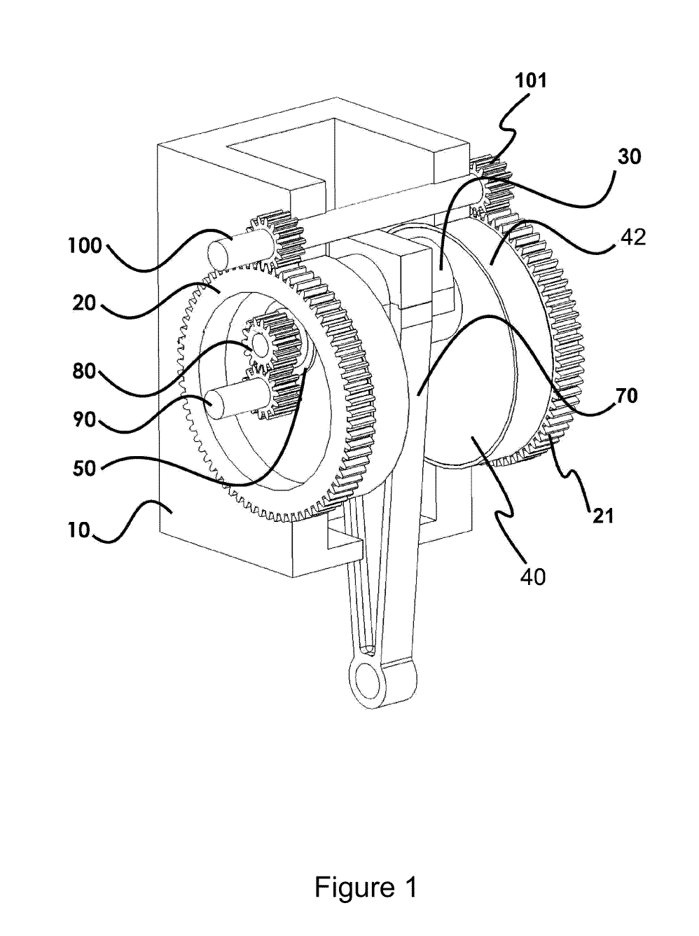

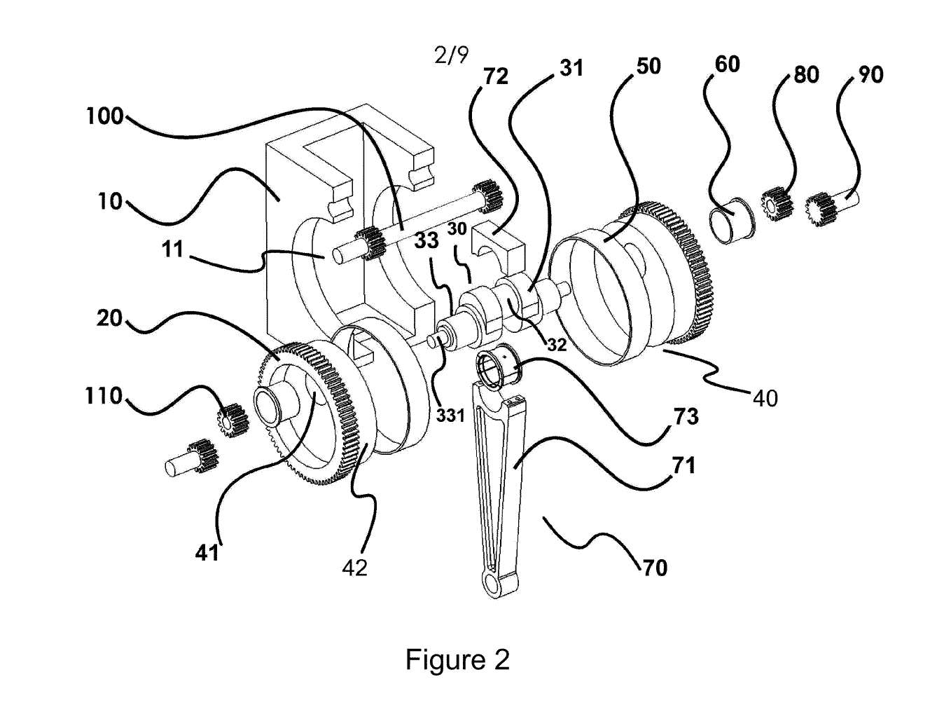

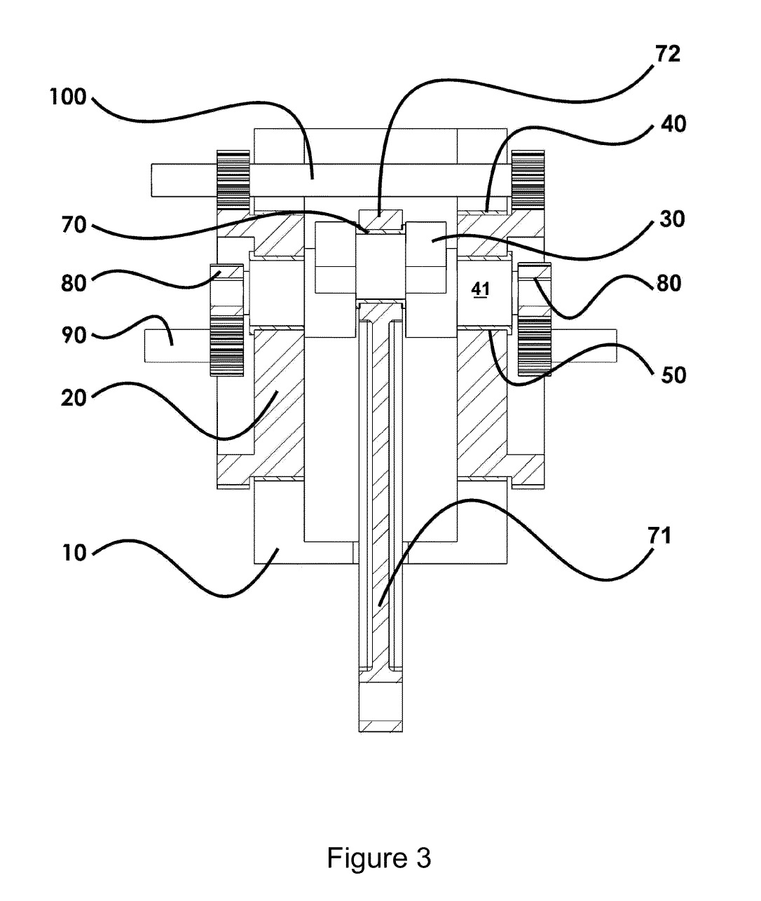

With reference to FIG. 1, the subject matter mechanism is positioned on a press upper bridge (10) and essentially comprises a gear box in order to move a connecting arm (70) as detailed below which is hinged thereon. Said gear box comprises an outer crank spindle (20) placed into the bearing slot (11) on the press upper bridge (10). In more details, there is an outer crank spindle bearing (40) which is connected to the outer crank spindle (20) in a fixed manner and which is preferably one piece to the outer crank spindle (20), and said outer crank spindle bearing (40) is placed to the bearing slot (11). The outer crank spindle bearing (40) is preferably in the form of a cylinder whose base diameter is greater than the height thereof and accordingly, it is seated into a bearing slot (11) through an outer crank spindle bushing (50) which is engaged to the seating surface (42) forming the outer circumference thereof.

The outer circumference of said outer crank spindle (20) is in geared form and accordingly, the outer crank spindle drive gear (100) which is driven by a servo motor (not illustrated in the figure) is connected to said geared surface (21) through the geared part (101) included. Thus, the outer crank spindle (20), and the outer crank spindle bearing (40) which is connected to the outer crank spindle (20) can be rotated in a controllable manner by means of said servo motor. In an alternative embodiment of the subject matter invention, the outer crank spindle can also be driven through a flywheel and in this case, optionally an asynchronous motor can be used as the first drive source instead of servo. Depending on the characteristics of the asynchronous motor, in such a system, a clutch-brake mechanism may have to be adapted to the press.

On the other hand, on the lateral surface of the outer crank spindle bearing (40), there is an inner crank spindle bearing (41) which is formed as eccentric from the center and the inner crank spindle (30) whereon the connecting arm (70) is connected is rotatably bedded inside said inner crank spindle bearing (41) and thus, by means of another drive source which is preferably a servo motor, it can be rotated around itself inside the inner crank spindle bearing (41). For the bearing to be realized in a firm manner, there is an inner spindle bushing (60) inside the inner crank spindle bearing (41).

In more details, the inner crank spindle (30) has an inner crank spindle pivot (33) with an extension whereon the inner crank spindle gear (80) is placed and which provides placement into the inner crank spindle bearing (41). At the continuation of said inner crank spindle pivot (33), an eccentric part (31) is formed. At the continuation of the eccentric part (31), there is an arm connection pivot (32) whereon the connecting arm (70) is placed. Accordingly, an inner crank spindle gear (80) is fixed to the gear bearing (331) on the inner crank spindle pivot (33). With reference to FIG. 1, the inner crank spindle gear (80) stands so as to extend outwardly from the lateral surface of the outer crank spindle bearing (40) facing outwardly and here, it is in connection with an inner crank spindle drive gear (90) which is rotated by a servo motor. Thanks to this, as the drive gear (90) rotates, the inner crank spindle (30) rotates around itself. Depending on this, the connecting arm (70) hinged to the eccentric part (31) moves at a distance equal to the eccentricity diameter (Rinner) of the inner crank spindle (30).

As a result, thanks to the nested bed design provided in the subject matter invention, the inner crank spindle (30) is bedded inside the outer crank spindle (20) on the outer crank spindle bearing (40). At the same time, the outer crank spindle (20) and the inner crank spindle (30) can be rotated in a controllable manner around their own axes independently of each other by means of the related servo motors providing drive to them. Thanks to this, the outer crank spindle (20) and the inner crank spindle (30) can be rotated independently of each other with different speeds optionally in the same direction or in opposite directions. Accordingly, thanks to this novel construction which provides that the outer and inner crank spindle (20, 30) bed each other as one within the other, the degree of freedom of the gear box is equal to 2. At the same time, in the subject matter system, by means of the braking resistance of one of the servo motors, the degree of freedom can be decreased to 1. Another characteristic of the subject matter system is that, thanks to the nested bearing, a rigid structure is formed which can meet the high pressing forces. Since, the force transferred to the inner crank spindle (30) through the connecting arm (70) is transferred to the outer crank spindle bearing (40) with a more rigid structure through the inner crank spindle bearing (41) and from there, it is transferred through the bearing slot (11) to the press upper bridge (10) which has a much more rigid structure.

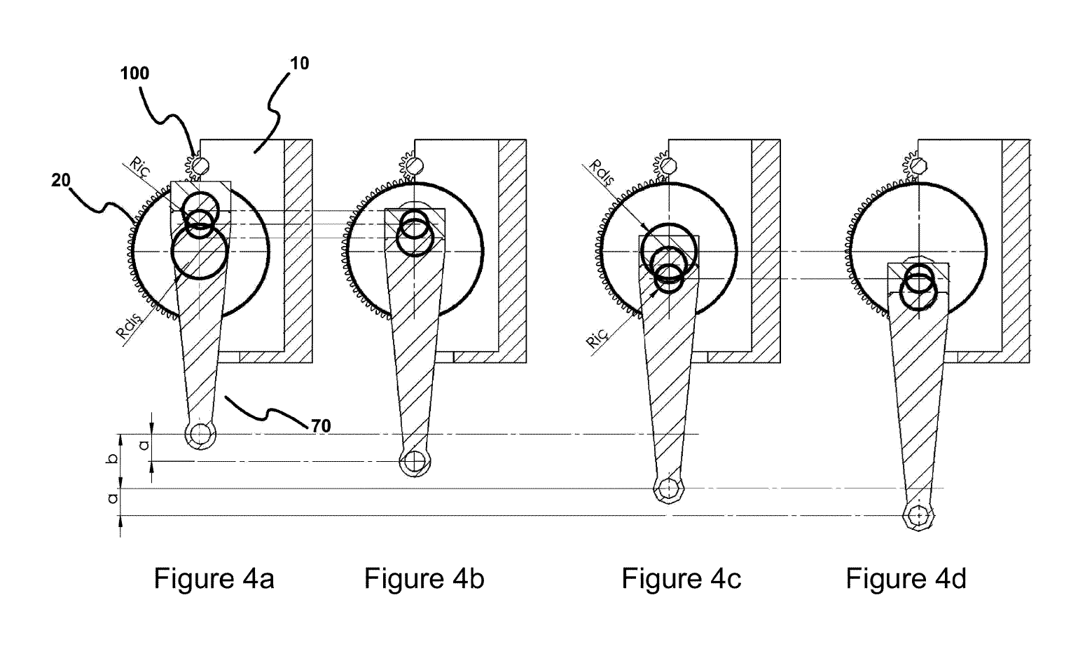

In the subject matter invention, by means of the angular movement of the outer crank spindle (20) which is rotated by means of the servo motor on the outer crank spindle drive gear (100), the connecting arm (70) can be operated in different positions. Examples of this operating style are given in FIG. 4a and FIG. 4c. In FIG. 4a and FIG. 4c, thanks to the outer crank spindle eccentricity diameter (Router), the mentioned adjustment can be provided inside the distance equal to the outer crank spindle course (b) by means of the circular movement in the rotation center. Thanks to this characteristic, an alternative solution is provided for the tuning distance adjustment mechanism realized by means of the screwed systems in classical presses. However, in this adjustment range, since the system can realize circular movement equal to the inner crank spindle eccentricity diameter (Rinner), the required course amount for the piece to be shaped is limited by the inner crank spindle course (a).

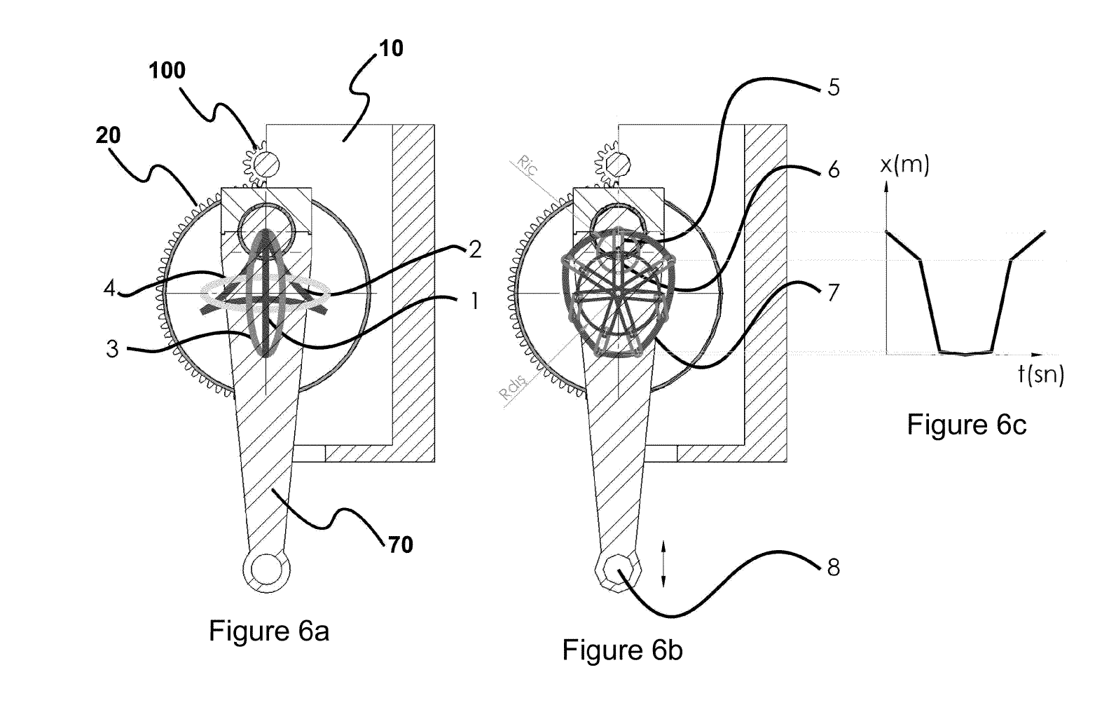

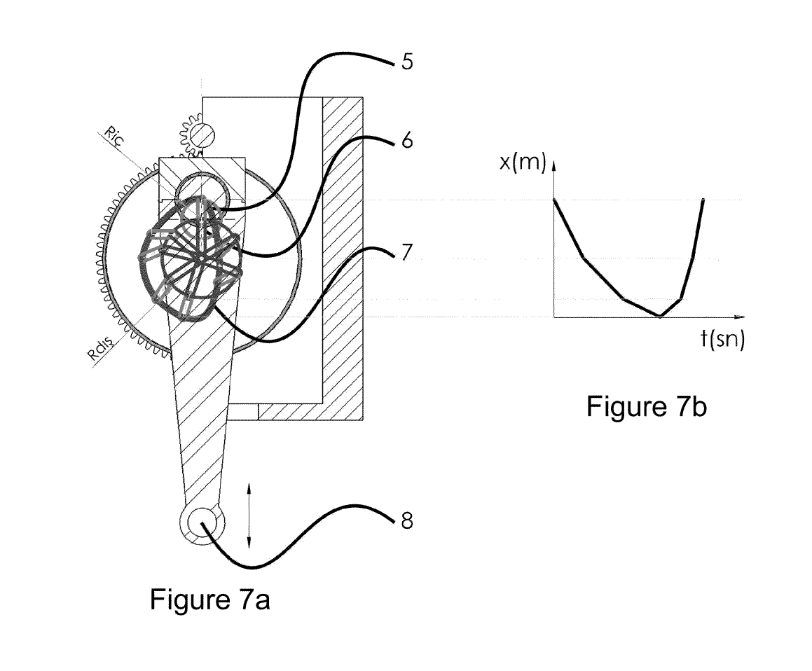

Moreover, with reference to FIG. 6a, depending on the inner crank spindle eccentricity diameter (Rinner) and outer crank spindle eccentricity diameter (Rₒᵤₜₑᵣ), the outer crank spindle (20) and the inner crank spindle (30) can be rotated with different angular speeds in the same direction or in different directions, a movement characteristic can be obtained within the scope of the orbits (1, 2, 3 and 4) which can also be provided with other systems. At the same time, since the degree of freedom of the subject matter mechanism is equal to two, orbits which have a plurality of functions which can not be obtained with the known systems can be obtained by means of this embodiment. For instance, in FIG. 6b, the inner crank spindle eccentricity diameter (Rinner) is illustrated by the arm numbered 5 and the outer crank spindle eccentricity diameter (Router) is illustrated by the arm numbered 6. In order to obtain the orbit (7) illustrated in FIG. 6b, the movement style of the arms numbered 5 and 6 is illustrated. The connecting arm bushing (73) axis moves on the orbit (7) illustrated in FIG. 6b, the route-time graphic is illustrated in FIG. 6c, where this route-time graphic is formed by the connecting arm (70) lower axis illustrated by number 8 in FIG. 6b. In order to obtain the orbit (7) in FIG. 7a, the route-time graphic is illustrated in FIG. 7b, where this graphic is formed by means of the movements of the arms numbered 5 and 6 and by means of the lower axis of the connecting arm (70) illustrated by number 8.

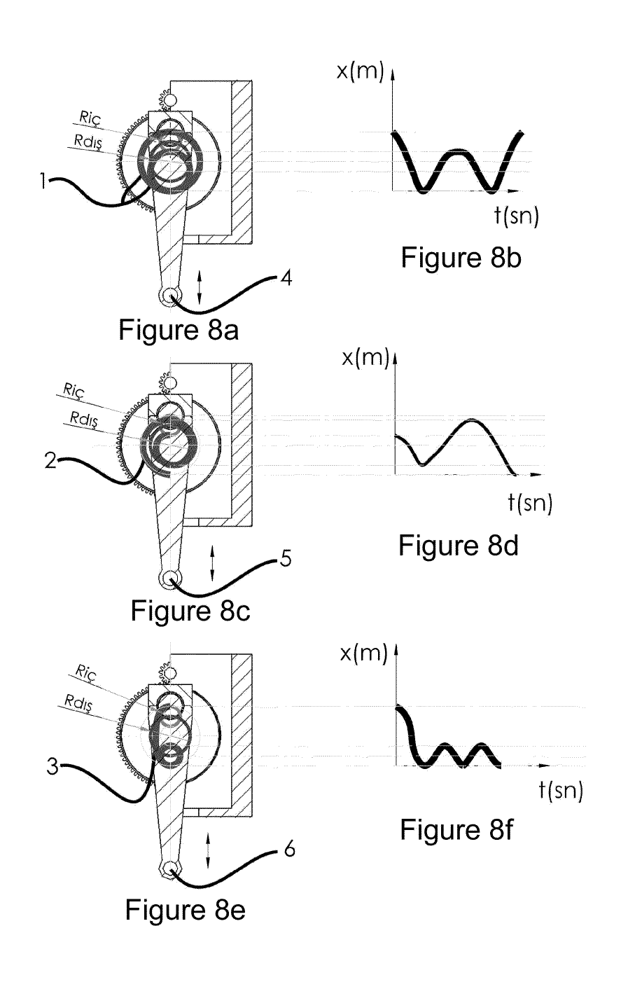

In FIG. 6b and FIG. 7a, examples of movements which repeat each other are given. Apart from these, by means of this system, movements which repeat themselves once in two strokes or which do not repeat themselves can be provided. The route-time graphic which is formed by the connecting arm bushing (73) axis moving on the orbit (1) in FIG. 8a and which is formed by the connecting arm (70) lower axis illustrated by number 4 in FIG. 8a are illustrated in FIG. 8b. In this graphic, there is an example of an orbit which repeats itself once in two returns. Examples of orbits which do not repeat themselves and examples of ram table route-time graphics are given in FIG. 8c, FIG. 8d, FIG. 8e and FIG. 8f.

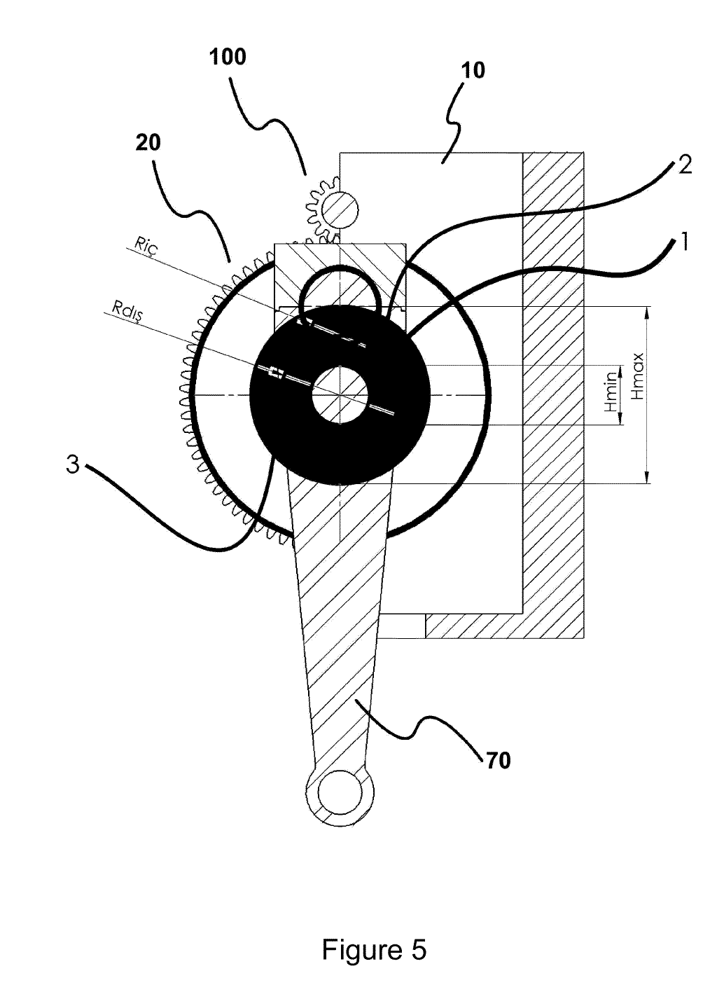

On the other hand, the orbits which can be obtained for this system and ram table route-time graphics can not be limited by the examples given in this specification. In FIG. 5, all of the orbits remaining inside the shaded region illustrated by number 3 can be obtained between the circles numbered 1 and 2 where the minimum course (Hₘᵢₙ) and the maximum course (Hₘₐₓ) are formed, thanks to this, since the desired route-speed parameters in the press ram table will be adjusted according to the characteristics of the piece, the piece shaping processes will be realized in a much simpler manner.

Accordingly, thanks to the subject matter invention, so that said shaded area will form a limit, the desired course adjustment, tuning adjustment and stroke characteristic can be realized by means of software, without the need for any piece change and without the need to stop the press. The parameters which will be used in this adjustment process are the following parameters: the speed, power and drive characteristic of the servo motor driving the outer crank spindle, the speed, power and drive characteristic of the servo motor driving the inner crank spindle, inner crank spindle eccentricity diameter (Rinner) and outer crank spindle eccentricity diameter (Rₒᵤₜₑᵣ). By means of the Rinner and Rₒᵤₜₑᵣ parameters, the area which the circle given in FIG. 5 covers can be increased or decreased, and by means of other parameters, the stroke characteristic can be determined as desired in an electronically controlled manner. Moreover, by means of an electronic torque control to be realized in servo motors, there is no need for overload mechanisms in the presses where the subject matter invention is used.

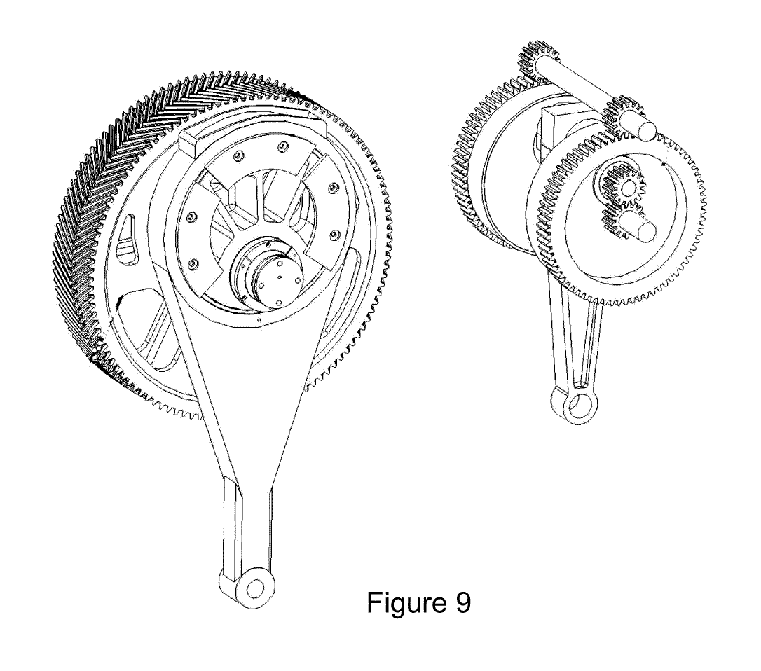

On the other hand, as can be seen in FIG. 9, by means of the subject matter mechanism with a nested bearing system, the mechanism of an eccentric press can be seen which belongs to the known situation of the technique with the same course. As can be seen from the figure, the subject matter system has smaller volumes dimensionally when compared with the present systems. Therefore, an important amount of material gain is obtained when compared with the other systems.

In addition to the abovementioned details, the connecting arm (70) preferably comprises a lower connecting arm (71) and a connecting arm cap (72) assembled to the upper part of the lower connecting arm (71). Accordingly, the arm connection pivot (32) of the eccentric part enters into the space between the upper part of the lower connecting arm (71) and the connecting arm bushing (73), and the connecting arm (70) is placed into the arm connection pivot (32) through a connecting arm bushing (73) in a movable manner.

The protection scope of the present invention is set forth in the annexed Claims and cannot be restricted to the illustrative disclosures given above, under the detailed description. It is because a person skilled in the relevant art can obviously produce similar embodiments under the light of the foregoing disclosures, without departing from the main principles of the present invention.

1. A movement transformation mechanism which can be used in presses and where independent power transfer can be realized to the connecting rod from two separate drive sources, the movement transformation mechanism comprising: an outer crank spindle with circular gear form which is rotated by the first drive source; an outer crank spindle bearing which is connected to said outer crank spindle in a fixed manner and thereby which rotates together with the crank spindle and which has an inner crank spindle bearing formed on the lateral surface as eccentric from the center; and an inner crank spindle which is rotated by the second drive source and which has an eccentric part whereon the connecting rod is hinged, and characterized in that moreover, in said mechanism, the inner crank spindle is rotatably bedded inside said inner crank spindle bearing, in order for the inner crank spindle to rotate around itself and at the same time, in order to provide the inner crank spindle to make orbital movement together with the outer crank spindle bearing.

2. The movement transformation mechanism according to claim 1, further comprising an outer crank spindle drive gear in connection with the first drive source, and by comprising a geared surface which is in connection with said outer crank spindle drive gear and which is formed at the outer circumference of the outer crank spindle, in order to transfer the movement of said first drive source to the outer crank spindle.

3. The movement transformation mechanism according to claim 1, further comprising an inner crank spindle drive gear connected to the second drive source and by comprising an inner crank spindle gear which is connected to said inner crank spindle drive gear and which is connected to the inner crank spindle in a fixed manner, in order to transfer the movement of said second drive source to the inner crank spindle.

4. The movement transformation mechanism according to claim 1, further comprising an inner crank spindle bushing, in order to provide the bearing of the inner crank spindle firmly inside said inner crank spindle bearing.

5. The movement transformation mechanism according to claim 1, further comprising an outer crank spindle bushing which is placed onto the seating surface forming the outer circumference of the outer crank spindle bearing.

6. The movement transformation mechanism according to claim 1, wherein the outer crank spindle bearing is placed into the bearing slot in a rotatable manner which exists on the upper bridge of a press.

7. The movement transformation mechanism according to claim 1, wherein said outer crank spindle bearing has a cylindrical form extending orthogonally during operation and accordingly, it is formed far away from the center on the lateral surface of the inner crank spindle bearing.

8. The movement transformation mechanism according to claim 1, further comprising an inner crank spindle pivot which is placed to the inner crank spindle bearing of the inner crank spindle; said eccentric part extending at the continuation of said inner crank spindle pivot; and an arm connection pivot which extends at the continuation of said eccentric part and whereon the connecting rod is connected.

9. The movement transformation mechanism according to claim 1, wherein said first and second drive sources are one each servo motor.
